(19) United States
(12) Patent Application Publication
(10) Pub. No.: US 2023/0133868 A1
(43) Pub. Date: May 4, 2023

(54) COMPUTER-READABLE RECORDING MEDIUM STORING EXPLANATORY PROGRAM, EXPLANATORY METHOD, AND INFORMATION PROCESSING APPARATUS

(71) Applicant: Fujitsu Limited, Kawasaki-shi (JP)

(72) Inventors: Masaru TODORIKI, Kita (JP); Koji MARUHASHI, Hachioji (JP)

(73) Assignee: Fujitsu Limited, Kawasaki-shi (JP)

(21) Appl. No.: 17/945,102

(22) Filed: Sep. 15, 2022

(30) Foreign Application Priority Data
Nov. 4, 2021 (JP) 2021-180686

(51) Int. Cl. G06N 20/00; G06K 9/62; G06N 5/04

(52) U.S. Cl. CPC G06N 20/00; G06K 9/6286; G06K 9/6224; G06N 5/045

(57) ABSTRACT

A recording medium storing an explanatory program for causing a computer to execute an explanatory process. The process includes: generating a plurality of pieces of data based on first data; calculating a ratio of output results, among a plurality of results output in a case that each of the plurality of pieces of data is input to a machine learning model, different from first results output in a case that the first data is input to the machine learning model; generating a linear model based on the plurality of pieces of data and the plurality of results in a case that the calculated ratio satisfies a criterion; and outputting explanatory information with respect to the first results based on the linear model.

### CROSS-REFERENCE TO RELATED APPLICATION

This application is based upon and claims the benefit of priority of the prior Japanese Patent Application No. 2021-180686, filed on Nov. 4, 2021, the entire contents of which are incorporated herein by reference.

### FIELD

The embodiments discussed herein are related to explanatory techniques with respect to inference results of machine learning models.

### BACKGROUND

With the progress of machine learning, while high-performance machine learning models are obtained, inference results of the machine learning models are desired to be explained. An algorithm referred to as local interpretable model-agnostic explanations (LIME) has been proposed as an Explainable AI (XAI) technique that explains reasons, grounds, or the like for the inference results being obtained.

According to LIME, new data is generated in neighborhoods of explanation target data, and a linear approximation model (hereafter, referred to as a linear model) of a machine learning model related to an explanatory variable is constructed using the neighborhood data. From this linear model, a partial regression coefficient value of the explanatory variable with respect to the explanation target data is obtained based on a relationship between the neighborhood data and prediction results. According to LIME, as the partial regression coefficient value obtained from the linear model of the machine learning model in this manner is larger, the more the obtained value may be regarded as an important explanatory variable for explaining the prediction results, so that the explanations serving as the grounds for the inference results may be obtained.

Japanese Laid-open Patent Publication No. 2019-191895, U.S. Patent Application Publication No. 2020/0279182, and Japanese Laid-open Patent Publication No. 2020-140466 are disclosed as related art.

### SUMMARY

According to an aspect of the embodiments, a computer-readable recording medium storing an explanatory program for causing a computer to execute a process, the process including: generating a plurality of pieces of data based on first data; calculating a ratio of output results, among a plurality of results output in a case that each of the plurality of pieces of data is input to a machine learning model, different from first results output in a case that the first data is input to the machine learning model; generating a linear model based on the plurality of pieces of data and the plurality of results in a case that the calculated ratio satisfies a criterion; and outputting explanatory information with respect to the first results based on the linear model.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a descriptive diagram for describing an example of neighborhood data;

FIG. 2 is a descriptive diagram for describing generation of neighborhood data;

FIG. 3 is a descriptive diagram for describing method for generating neighborhood data;

FIG. 4 is a descriptive diagram for describing a relationship between a ratio of neighborhood data where a class has changed and explanatory accuracy;

FIGS. 5A and 5B include descriptive diagrams each describing a relationship between a ratio of neighborhood data where a class has changed and explanatory accuracy;

FIG. 6 is a block diagram illustrating an example of a functional configuration of an information processing apparatus according to an embodiment;

FIG. 7 is a flowchart illustrating an example of operations of an information processing apparatus according to an embodiment; and

FIG. 8 is a descriptive diagram for describing an example of a configuration of a computer.

### DESCRIPTION OF EMBODIMENTS

According to the above-described related art, in a case where explanatory information for an inference result is generated using a linear model, there is a problem that reliability of the explanatory information is lowered in some cases depending on approximate data for generating the linear model.

For example, in a case where explanation target data is graph data or the like including nodes and edges, because the graph data has a complicated data structure and there are a wide variety of variations, it is difficult to generate neighborhood data appropriate for the generation of a linear model. For this reason, the accuracy of the linear model is degraded in some cases, and the reliability of the explanatory information is lowered.

In one aspect, an object is to provide an explanatory program, an explanatory method, and an information processing apparatus capable of obtaining explanatory information with a higher level of reliability.

Hereinafter, an explanatory program, an explanatory method, and an information processing apparatus according to an embodiment will be described with reference to the drawings. In the embodiment, configurations having the same functions are denoted by the same reference signs, and redundant description thereof is omitted. The explanatory program, the explanatory method, and the information processing apparatus described in the following embodiment are merely examples, and are not intended to limit the embodiment. Each of the following embodiments may be appropriately combined with each other within a range without any contradiction.

An information processing apparatus according to an embodiment is an apparatus configured to generate explanatory information for explaining an inference result of a machine learning model with respect to explanation target data by using an algorithm of LIME, and output the generated explanatory information. For example, a personal computer (PC) or the like may be applied as the information processing apparatus according to the embodiment.

Examples of the explanation target data include table data, text data, image data, graph data, and the like. In the embodiment, as an example, graph data is taken as the explanation target data.

Table data is, for example, data such as numerical values and categories arranged orderly in two dimensions. In the table data, values (for example, age, sex, and nationality) present in the table serve as feature amounts. Text data is, for example, data such as a word string continuously arranged in one dimension. In the text data, a probability of a word that appears following a specific word, for example, is a feature amount. Image data is, for example, data such as pixels arranged orderly in two dimensions and color information thereof. In the image data, a position and a color of the pixel, derivative information thereof, and the like serve as feature amounts.

Graph data is data indicating a graph structure formed by nodes and edges each coupling the nodes to each other, for example, such data as a set of nodes and edges coupling the nodes that are present non-structurally in multiple dimensions, and attribute information thereof. In the graph data, the number of nodes, the number of edges, the number of branches, the number of hops, information representing a subgraph structure, coupling information of nodes, shortest path information, and the like serve as feature amounts.

An overview of the LIME algorithm executed by the information processing apparatus will be described below. According to the LIME algorithm, with respect to an input instance which is explanation target data, uniformly distributed neighborhood data is generated (for example, about 100 to 1000 pieces for one input instance) by varying part of data.

Subsequently, in the LIME algorithm, the generated neighborhood data is given as input to the machine learning model so as to obtain output (a presumption result of the neighborhood data). The output from the machine learning model is, for example, a prediction probability of a class in the case of class classification or a numerical prediction value in the case of regression.

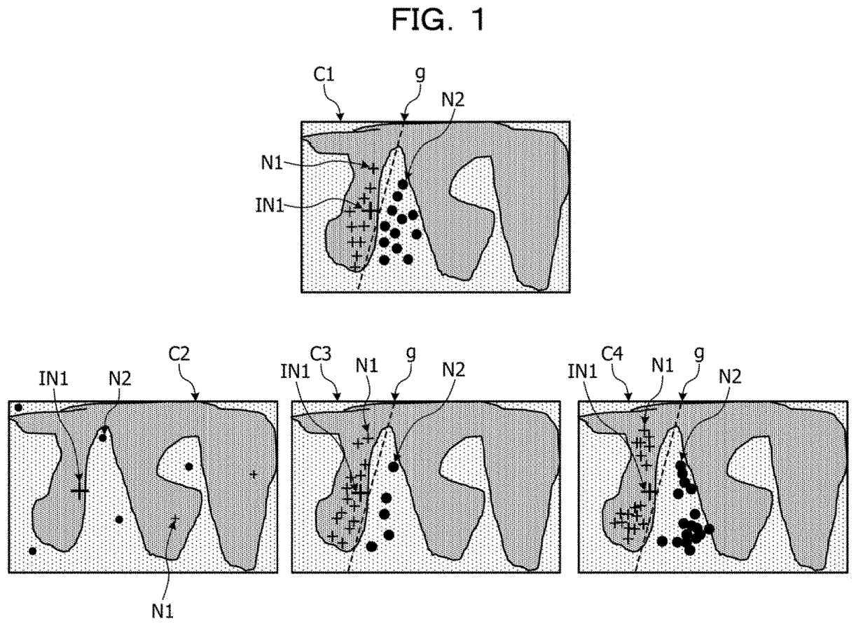

FIG. 1 is a descriptive diagram for describing an example of the neighborhood data. For example, in FIG. 1, a feature amount included in an input instance IN1 is simplified (binarized), and the feature space is depicted as a plane. Shading in FIG. 1 indicates a class classification result (Class A (dark shading) or Class B (light shading)) in a machine learning model.

As illustrated in a case C1 in FIG. 1, regarding the input instance IN1, a plurality of pieces of neighborhood data N1 and N2 are generated by varying part of the feature amount included in the data. The neighborhood data N1 is data whose presumption result belongs to Class A, and the neighborhood data N2 is data whose presumption result belongs to Class B.

Subsequently, in the LIME algorithm, each piece of the neighborhood data N1 and N2 is given as input to a distance function (for example, cos similarity in the case of text classification) so as to obtain distance information. Subsequently, in the LIME algorithm, the distance information of each piece of the neighborhood data N1 and N2 is given as input to a kernel function (for example, an exponential kernel) so as to obtain a sample weight (similarity).

Subsequently, in the LIME algorithm, the feature amount of each piece of the neighborhood data N1 and N2 is taken as an explanatory variable (x₁, x₂, . . . , xₙ), and the output (presumption result) of each piece of the neighborhood data N1 and N2 is taken as an objective variable (y) and is approximated by a linear model g through a regression operation such as ridge regression. At the time of optimization in the regression operation, each piece of the neighborhood data N1 and N2 may be weighted by a sample weight (similarity). As a result, in the LIME algorithm, the linear model g related to each explanatory variable (x₁, x₂, . . . , xₙ) as represented in the following equation is obtained regarding the input instance IN1 which is explanation target data.

y=β₁x₁+β₂x₂+ . . . +βₙxₙ

In the equation of the linear model g described above, a feature amount with a large coefficient (β₁, β₂, . . . βₙ) may be regarded as a feature amount having a large contribution degree (influence) to the prediction. Conversely, a feature amount with a small coefficient may be regarded as a feature amount having a small contribution degree to the prediction.

As an example, it is assumed that the linear model g is represented by an equation with coefficients as follows.

y=10.5x₁+(−0.02)x₂+ . . . +0.35xₙ

In this case, because the coefficient of the feature amount x₁ is relatively large to be 10.5, the output y tends to increase along with a change of the feature amount x₁. Accordingly, the feature amount x₁ may be regarded as an important feature having a large contribution degree to the prediction.

Because the coefficient of the feature amount x₂ is relatively small to be (−0.02), the output y hardly changes even when the feature amount x₂ changes. Accordingly, the feature amount x₂ may be regarded as an unimportant feature having a small contribution degree to the prediction.

The information processing apparatus outputs the important feature amount (explanatory variable) obtained by the LIME algorithm in this manner as explanatory information indicating the grounds for inference of the machine learning model with respect to the input instance IN1 as the explanation target data.

Reliability of the explanatory information is significantly affected by the distribution state in the feature space of the neighborhood data N1 and N2 generated from the input instance IN1. For example, as illustrated in a case C2 in FIG. 1, when unexpected pieces of the neighborhood data N1 and N2 separated from the input instance IN1 are generated in the feature space, or when the number of pieces of the neighborhood data N1 and N2 is small, it is difficult to determine a linear model g for obtaining the explanatory information.

As illustrated in a case C3 in FIG. 1, when there is a large difference between the number of pieces of the neighborhood data N1 belonging to Class A and the number of pieces of the neighborhood data N2 belonging to Class B (the number of pieces of the neighborhood data N1 is much larger in the illustrated example), the linear model g is affected by the difference in number mentioned above.

As illustrated in a case C4 in FIG. 1, even when the numbers of pieces of the neighborhood data N1 and N2 are substantially the same, in the case where the distribution is not uniform (the distribution is biased) (the neighborhood data N2 is concentrated at a position separated from the input instance IN1 in the illustrated example), the linear model g is affected by the bias of the distribution.

It is difficult to accurately control such a distribution state of the neighborhood data N1 and N2; for example, in a case where the input instance IN1 is graph data, it is considerably difficult to control the distribution state of the neighborhood data N1 and N2 due to a complicated graph structure of the graph data.

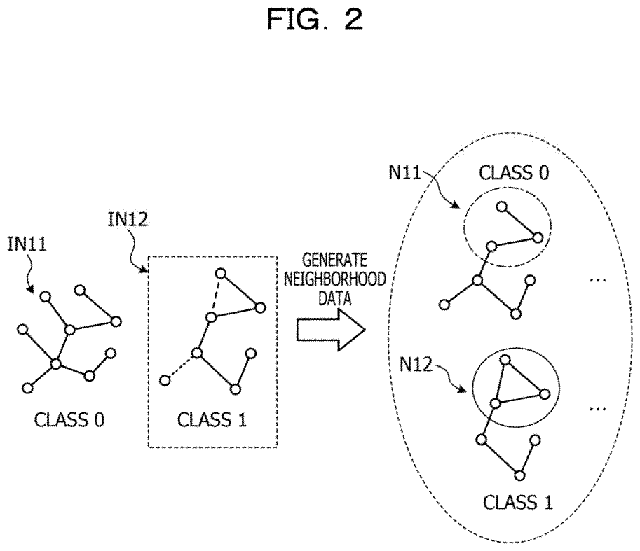

FIG. 2 is a descriptive diagram for describing the generation of the neighborhood data. As illustrated in FIG. 2, input instances IN11 and IN12 as explanation target data are graph data having a graph structure constituted by nodes and edges. In the illustrated example, it is assumed that class classification (Class 0: having no triangle portion, Class 1: having a triangle portion) is performed based on a triangle problem (whether there is a triangle portion).

For example, neighborhood data N11 generated by varying part of data (removing one edge) from the input instance IN12 belonging to Class 1 is made to have no triangle portion, and thus the class thereof changes from Class 1 to 0. By contrast, neighborhood data N12 generated by larger variation (removing one edge and removing a node) stays in a state of having a triangle portion, and therefore there is no class change.

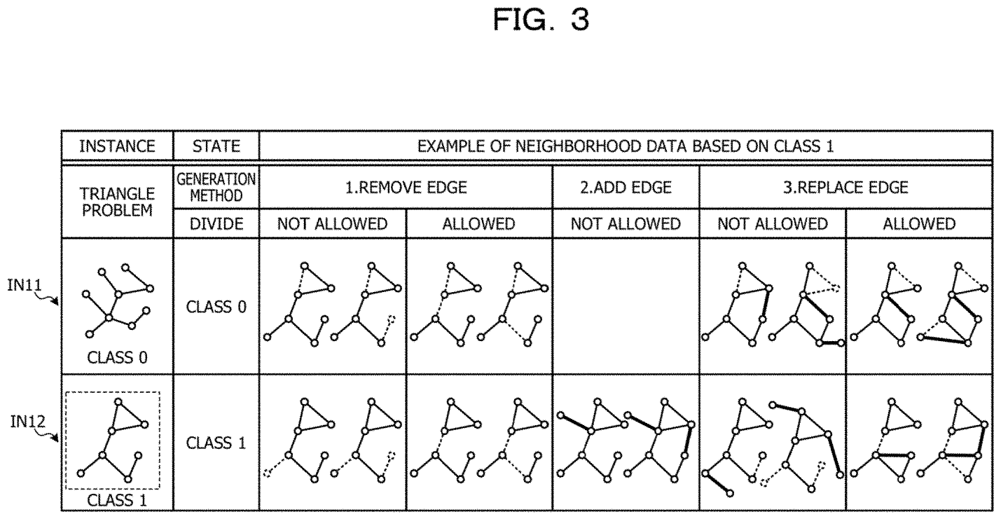

FIG. 3 is a descriptive diagram for describing a method for generating neighborhood data. As illustrated in FIG. 3, the method for generating neighborhood data from the input instances IN11 and IN12 each having a graph structure includes removing an edge, adding an edge, and replacing an edge when focusing on edges, for example.

When an edge is removed, the number of nodes and the number of edges decrease in response to the removal of the edge. When an edge is added, the number of nodes and the number of edges increase in response to the increase of the edge. When an edge is replaced, the number of nodes and the number of edges are unchanged. According to the method for generating neighborhood data based on graph data, there is a case in which an original graph structure is allowed to be divided into a separated state and a case in which the original graph structure is not allowed to be divided.

The generation of neighborhood data based on graph data may be performed by any one of the above methods or a plurality of combinations of the methods. Accordingly, in a case of generating the neighborhood data N11, N12, and the like from the input instances IN11 and IN12 having the graph structure, it is considerably difficult to control the distribution state of the neighborhood data N1 and N2.

Regarding the distance function with respect to the neighborhood data N11, N12, and the like of the graph structure, there are a distance based on graph division, an edit distance of an adjacency matrix and an incidence matrix, cos similarity, and a graph kernel function, for example. Examples of the graph kernel function include Random walk kernels, shortest path, graphlet kernel, Weisfeiler-Lehman kernels, GraphHopper kernel, Graph convolutional networks, Neural message passing, GraphSAGE, SplineCNN, k-GNN, and the like. Evaluation of the distribution of the neighborhood data changes depending on selection of these distance functions.

Examples of the machine learning model for graph data includes various models such as Graph Neural Network (GNN), Graph Convolutional Network (GCN), and Support Vector Machine (SVM) with Graph Kernel. For this reason, the generation of explanatory information may be affected by the prediction accuracy of the selected machine learning model.

For example, in a case where the prediction accuracy of the machine learning model is high, stability is obtained in class determination of the neighborhood data N11 and N12 of the graph structure, and the reliability of the linear model g is improved. Even when the prediction accuracy is high, in a case where there is a bias or the like in the distribution state of the neighborhood data N11 and N12 of the graph structure, the accuracy of the linear model g may be affected. In a case where the prediction accuracy of the machine learning model is low, an ambiguity occurs in the class determination of the neighborhood data N11 and N12 of the graph structure, and the reliability of the linear model g is lowered.

As described above, it is difficult to accurately control the distribution state of the neighborhood data N11 and N12, and thus the inventors examined general conditions under which high explanatory accuracy was obtained, based on statistics of the past cases.

For example, the inventors have examined a plurality of results output when each of the neighborhood data N11, N12, and so on is input to the machine learning model. Based on the plurality of results obtained by the neighborhood data N11, N12, and so on, the inventors determined a ratio of the output results different from the results output when the explanation target data (input instance IN12) as a source of the neighborhood data N11, N12, and so on was input to the machine learning model.

Because the neighborhood data (close to the boundary line) where the class changes is desired to be present in order to construct the linear model g for obtaining the explanatory information, it is considered appropriate that the determined ratio takes at least 50% as a criterion. Then, the inventors calculated explanatory accuracy (R100) of the plurality of results output when each of the neighborhood data N11, N12, and so on was input to the machine learning model, and evaluated the determined ratio.

The explanatory accuracy (R100) is as follows. 1. An explanatory score is calculated for each edge, and is normalized by [−1, 1] (plus indicates contribution to classification). 2. Ranking is made with the normalized explanatory scores. 3. The explanatory accuracy is calculated based on a ratio of whether the top n edges match the correct edges.

For example, in the case of explanatory accuracy (R100, n=3), the calculation is carried out considering that R100 is equal to (the number of edges, among the top three edges, that match the correct edges)/(the number of correct edges). R100 is an evaluation value of the explanatory accuracy corresponding to a relation of R100=1.0 in Recall 100%.

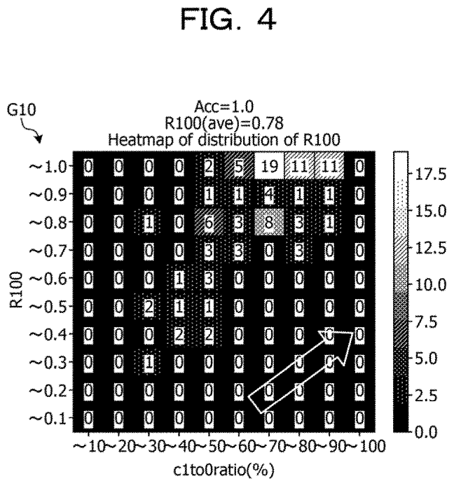

FIG. 4 is a descriptive diagram for describing a relationship between a ratio of neighborhood data where a class has changed and explanatory accuracy. For example, a graph G10 in FIG. 4 represents the relationship between a ratio (c1to0ratio) of neighborhood data where a class has changed with respect to the explanation target data and the explanatory accuracy (R100) by a frequency distribution (frequency graph). In the graph G10, the vertical axis indicates the explanatory accuracy (R100), and the horizontal axis indicates the ratio (c1to0ratio) of the neighborhood data where a class has changed with respect to the explanation target data. From the graph G10 in FIG. 4, it is understood that there is a tendency (an arrow depicted in the drawing) to go upward from left to right, where the explanatory accuracy (R100) is enhanced as the ratio (c1to0ratio) increases.

The inventors examined the above-described tendency by changing conditions such as a data set of explanation target data and a method for generating neighborhood data. For example, the inventors determined the graph G10 by using edge removal (without dividing the graph structure), a distance function (WL-Kernel/cos similarity), a machine learning model (GCN (prediction accuracy Acc=1.0)), and data extension (Noise presence/absence) as a method for generating neighborhood data.

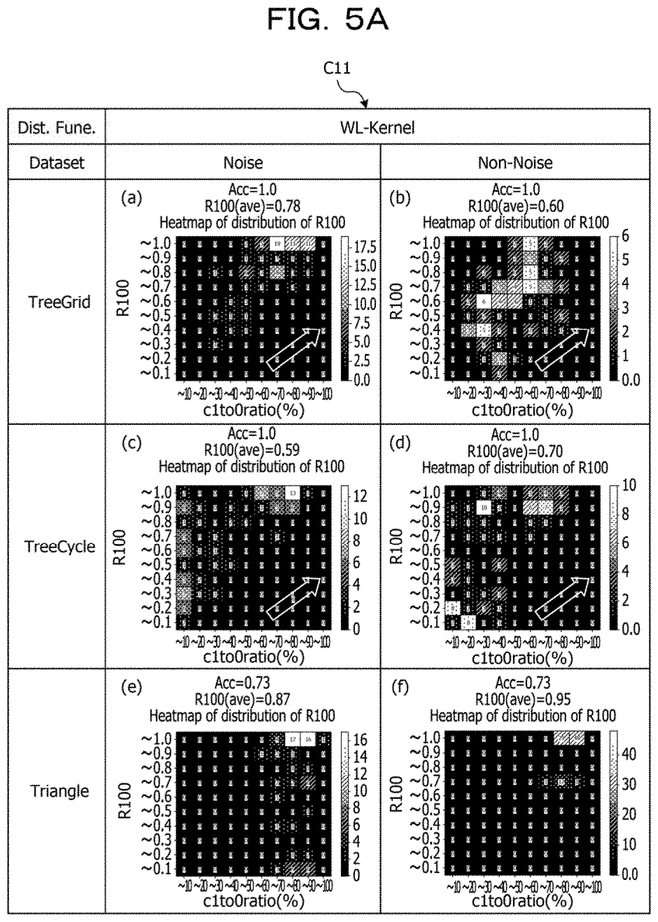

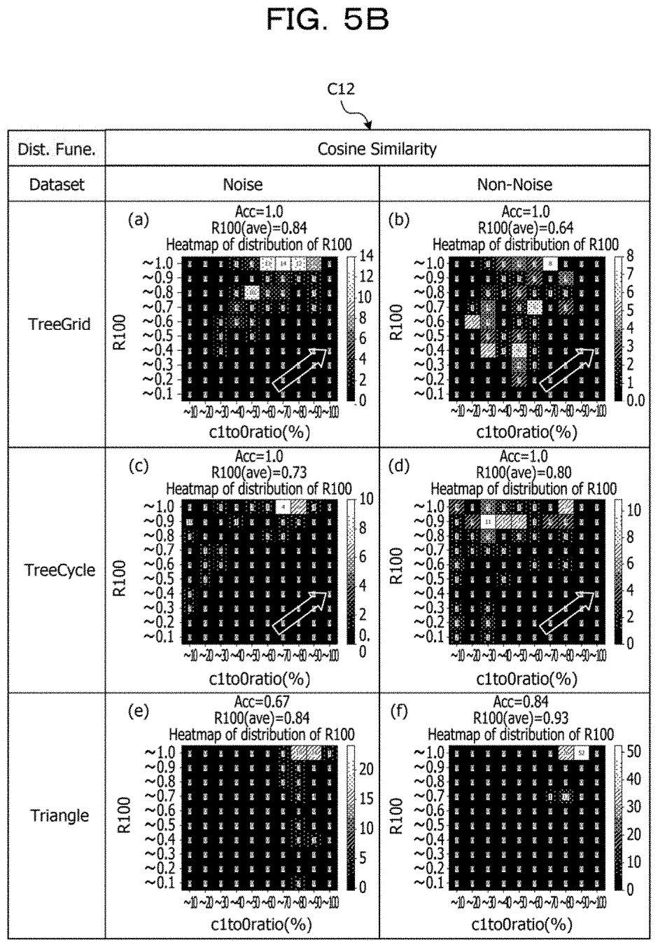

FIG. 5 includes descriptive diagrams each describing a relationship between a ratio of neighborhood data where a class has changed and explanatory accuracy. A case C11 in FIG. 5 indicates a case where the distance function is WL-Kernel. A case C12 indicates a case where the distance function is cos similarity. The data set has three types; they are TreeGrid including a Grid portion in the graph structure, TreeCycle including a Cycle portion therein, and Triangle including a Triangle portion therein.

As illustrated in the cases C11 and C12 in FIG. 5, when the c1to0ratio was in a range approximately from 60 to 80%, high explanatory accuracy was obtained in many verification examples (in a range of not less than 80%, low R100 (poor explanatory accuracy) was achieved in some cases). In a case where the prediction accuracy (Acc) was low, the reliability (explanatory accuracy) of the above-described condition was lowered in some cases.

As was an expected result, WL-Kernel took a tendency to have a smaller variation in explanatory accuracy (in the vertical axis direction) than the cos similarity, and a tendency to be more suitable for the evaluation of the distance of the graph data. Further, in a case where the data extension (Noise) was carried out, there was a tendency to have a smaller a variation in explanatory accuracy (R100).

It was confirmed that there was a difference in explanatory accuracy depending on the machine learning model, and it is considered that the effect of the prediction accuracy caused the above difference (in the case of SVM with Graph Kernel, the prediction accuracy exhibited a tendency to be low and the explanatory accuracy also exhibited a tendency to be low).

As long as the prediction accuracy (Acc) is high and the c1to0ratio is within a certain specific range, there is a possibility that high explanatory accuracy is obtained with high reliability. The certain specific range may be, for example, 50% or more. In a case where the c1to0ratio exceeds about 80%, because it is expected that the accuracy of the linear model g is lowered due to imbalance in the number of pieces of neighborhood data between classes or an increase in the number of pieces of neighborhood data far from the boundary line, it is considered that approximately 60 to 80%, which exceeds 50% but does not significantly exceed 50%, is more preferable.

From the above description, the general condition of the neighborhood data for obtaining high explanatory accuracy is defined such that the ratio (c1to0ratio) of the neighborhood data where a class has changed with respect to the explanation target data satisfies a specific criterion (for example, a range of 60 to 80%).

For example, the information processing apparatus according to the embodiment uses the LIME algorithm to calculate the ratio (c1to0ratio) of the neighborhood data where the class has changed with respect to the explanation target data when generating explanatory information for explaining the inference result of the machine learning model with respect to the explanation target data. Thereafter, in a case where the calculated ratio satisfies the criterion (for example, a range of 60 to 80%), the information processing apparatus generates a linear model g based on the plurality of pieces of neighborhood data and the results thereof, and outputs explanatory information based on the generated linear model g. This makes it possible to obtain more reliable explanatory information from the information processing apparatus according to the embodiment.

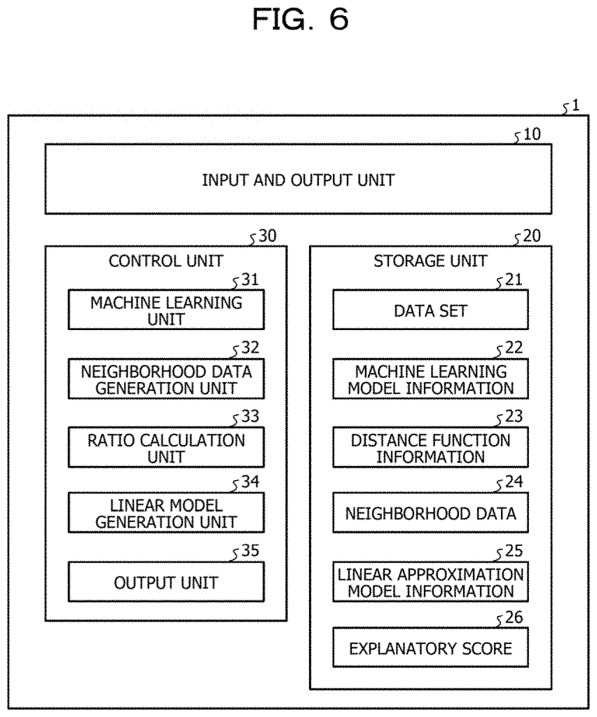

FIG. 6 is a block diagram illustrating an example of a functional configuration of an information processing apparatus according to the embodiment. As illustrated in FIG. 6, an information processing apparatus 1 includes an input and output unit 10, a storage unit 20, and a control unit 30.

The input and output unit 10 controls an input and output interface such as a graphical user interface (GUI) when the control unit 30 inputs and outputs various types of information. For example, the input and output unit 10 controls an input and output interface with an input device such as a keyboard and a microphone, and a display device such as a liquid crystal display device, which are coupled to the information processing apparatus 1. The input and output unit 10 controls a communication interface through which data communication with external devices coupled via a communication network such as a local area network (LAN) is performed.

For example, the information processing apparatus 1 receives input of the explanation target data (the input instances IN11, IN12, and the like) via the input and output unit 10. The information processing apparatus 1 receives various settings (for example, selection of the machine learning model and the distance function, a method for generating neighborhood data, and the like) via the GUI of the input and output unit 10.

The storage unit 20 corresponds, for example, to a semiconductor memory element such as a random-access memory (RAM) or a flash memory, or a storage device such as a hard disk drive (HDD). The storage unit 20 stores a data set 21, machine learning model information 22, distance function information 23, neighborhood data 24, linear approximation model information 25, an explanatory score 26, and the like.

The data set 21 is a set of training data used for training a machine learning model. For example, the data set 21 includes, for each of the cases, data that is assigned with a correct answer flag to be a correct answer of inference.

The machine learning model information 22 is data related to a machine learning model. For example, the machine learning model information 22 includes parameters and the like contained in a trained machine learning model such as a gradient boosting tree or a neural network.

The distance function information 23 is information related to a distance function. For example, the distance function information 23 includes parameters and the like used in an arithmetic expression and an arithmetic operation related to a distance function, such as a distance based on graph division, an edit distance of an adjacency matrix and an incidence matrix, cos similarity, and a graph kernel function.

The neighborhood data 24, the linear approximation model information 25, and the explanatory score 26 are data generated based on the explanation target data (input instances IN11, IN12, and the like) at the arithmetic operation time of LIME or the like. The neighborhood data 24 is data of approximately 100 to 1000 pieces of the neighborhood data generated based on the explanation target data by varying part of the data. The linear approximation model information 25 is information related to the linear model g generated based on the plurality of pieces of neighborhood data and the results thereof, and includes, for example, a coefficient value in each feature amount (explanatory variable). The explanatory score 26 is a value with respect to the explanatory information obtained by using the linear model g.

The control unit 30 includes a machine learning unit 31, a neighborhood data generation unit 32, a ratio calculation unit 33, a linear model generation unit 34, and an output unit 35. The control unit 30 may be achieved by a central processing unit (CPU), a microprocessor unit (MPU), or the like. The control unit 30 may also be achieved by a hard wired logic such as an application-specific integrated circuit (ASIC) or a field-programmable gate array (FPGA).

The machine learning unit 31 is a processing unit configured to generate a machine learning model by known machine learning using the data set 21. The machine learning unit 31 performs machine learning by using the data set 21 with a machine learning algorithm selected and determined in advance via the GUI or the like, and stores information regarding the trained machine learning model in the storage unit 20 as the machine learning model information 22. The machine learning model generated by the machine learning unit 31 may be a machine learning model based on a known machine learning algorithm, such as GNN, GCN, or SVM with Graph Kernel.

The neighborhood data generation unit 32 is a processing unit configured to generate a plurality of pieces of the neighborhood data 24 corresponding to the explanation target data, based on the explanation target data (the input instances IN11, IN12, and the like) received via the input and output unit 10.

For example, the neighborhood data generation unit 32 generates a predetermined number of pieces of the neighborhood data 24 (approximately 100 to 1000 pieces) by varying part of the explanation target data, based on the generation method of the neighborhood data determined in accordance with the settings via the GUI or the like, and stores the generated data in the storage unit 20.

The ratio calculation unit 33 is a processing unit configured to calculate the ratio (c1to0ratio) of the neighborhood data 24, in which the class has changed with respect to the explanation target data.

For example, the ratio calculation unit 33 inputs the explanation target data to the machine learning model constructed based on the machine learning model information 22, and obtains an inference result (for example, a class) with respect to the explanation target data. Subsequently, the ratio calculation unit 33 inputs each piece of the neighborhood data 24 to the machine learning model to obtain an inference result for each piece of the neighborhood data 24. Based on the obtained inference results, the ratio calculation unit 33 calculates the ratio (c1to0ratio) of the neighborhood data 24 having a different inference result from the inference result of the explanation target data among the inference results of the neighborhood data 24.

The linear model generation unit 34 is a processing unit configured to generate the linear model g based on the plurality of pieces of the neighborhood data 24 and the inference results thereof when the ratio calculated by the ratio calculation unit 33 satisfies a specific criterion (for example, a range of 60 to 80%).

For example, the linear model generation unit 34 determines whether the ratio calculated by the ratio calculation unit 33 satisfies a criterion set in advance via the GUI or the like. When the criterion is satisfied, the linear model generation unit 34 refers to the distance function information 23, and generates the linear model g by the above-mentioned known method using the distance function determined in accordance with the settings via the GUI or the like, the neighborhood data 24, and the inference results of the neighborhood data 24. After that, the linear model generation unit 34 stores, in the storage unit 20, the linear approximation model information 25 regarding the generated linear model g.

The output unit 35 is a processing unit configured to calculate and output the explanatory score 26 (explanatory information) based on the linear model g of the linear approximation model information 25. For example, the output unit 35 calculates the degree of contribution to the prediction in each feature amount (explanatory variable) based on the coefficient value in each feature amount of the linear model g by the above-described known method, and stores, in the storage unit 20, the calculated degree of contribution as the explanatory score 26. Subsequently, the output unit 35 outputs the explanatory score 26 to a display, an external device, or the like via the input and output unit 10.

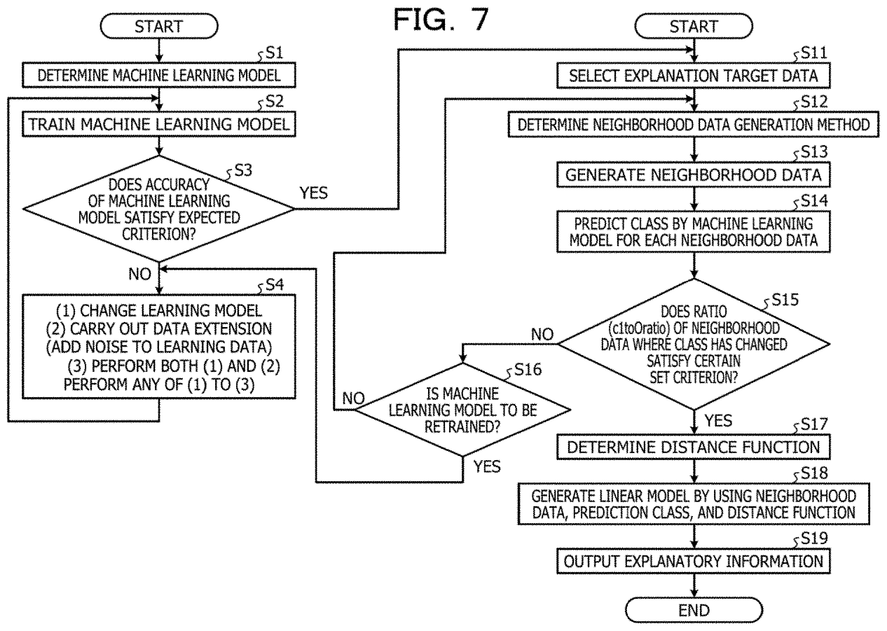

FIG. 7 is a flowchart illustrating an example of operations of the information processing apparatus 1 according to the embodiment. A flowchart on the left side in FIG. 7 illustrates processing related to machine learning performed by the machine learning unit 31. A flowchart on the right side in FIG. 7 illustrates processing related to explanatory information output performed by the neighborhood data generation unit 32, the ratio calculation unit 33, the linear model generation unit 34, and the output unit 35.

First, operations related to machine learning will be described. As illustrated in FIG. 7, when the processing related to machine learning is started, the machine learning unit 31 determines a machine learning model based on settings via the GUI or the like (S1). For example, the machine learning unit 31 determines the machine learning algorithm, selected through the GUI or the like, from among the known models such as GNN, GCN, and SVM with Graph Kernel.

Subsequently, based on the data set 21, the machine learning unit 31 trains a machine learning model in accordance with the determined machine learning algorithm (S2). Then, the machine learning unit 31 verifies the accuracy (Acc) of the trained machine learning model by using a data set for the verification that has not been used for the machine learning of the data set 21. A known verification method may be used for the verification of the accuracy. Based on the verification result, the machine learning unit 31 determines whether the accuracy of the machine learning model satisfies an expected criterion set in advance (for example, Acc is equal to or greater than a threshold) (S3).

When the expected criterion is satisfied (S3: Yes), the machine learning unit 31 stores information such as parameters related to the trained machine learning model in the storage unit 20 as the machine learning model information 22, and exits the processing related to the machine learning.

When the expected criterion is not satisfied (S3: No), the machine learning unit 31 performs any one of processing (1) to processing (3) described below, and thereafter returns the processing to S2 (S4). In this manner, the machine learning unit 31 retrains the machine learning model until the expected criterion is satisfied.

(1) Change the machine learning model among GNN, GCN, SVM with Graph Kernel, and the like.

(2) Carry out data extension of the data set 21 (add Noise to increase the number of pieces of data).

(3) Perform both (1) and (2).

The processing related to the explanatory information output will be described below. When the processing related to the explanatory information output is started, the neighborhood data generation unit 32 receives the selection of the explanation target data through the GUI or the like from among the input instances IN11, IN12, and so on input via the input and output unit 10 (S11).

Subsequently, the neighborhood data generation unit 32 determines a generation method of the neighborhood data based on the settings via the GUI or the like (S12). For example, as a generation method of the neighborhood data, the neighborhood data generation unit 32 determines a generation method from among any of the operations of removing an edge, adding an edge, and replacing an edge in the graph data, or from among combinations thereof, based on the settings. Based on the settings, the neighborhood data generation unit 32 may select whether or not to allow the original graph structure to be divided into a separated state.

Subsequently, based on the determined generation method, the neighborhood data generation unit 32 generates a predetermined number of pieces of the neighborhood data 24 by varying part of the explanation target data (S13).

Subsequently, the ratio calculation unit 33 inputs the explanation target data to the machine learning model constructed based on the machine learning model information 22, and obtains an inference result (for example, a class) for the explanation target data. Similarly, the ratio calculation unit 33 inputs each piece of the neighborhood data 24 to the machine learning model to predict an inference result (for example, a class) for each piece of the neighborhood data 24 (S14).

With this, based on the inference result obtained in S14, the ratio calculation unit 33 calculates a ratio (c1to0ratio) of the neighborhood data 24 having a different inference result from the inference result of the explanation target data among the inference results of the neighborhood data 24.

Subsequently, the linear model generation unit 34 determines whether the ratio (c1to0ratio) of the neighborhood data 24, in which the inference result has changed from the inference result of the explanation target data, satisfies a certain criterion (for example, a range of 60 to 80%) set via the GUI or the like (S15).

When the ratio (c1to0ratio) of the neighborhood data 24 does not satisfy the criterion (S15: No), the linear model generation unit 34 determines whether the retraining of the machine learning model is desired based on the accuracy (Acc) of the machine learning model (S16). For example, in a case where an expected criterion of the machine learning model is set to be relatively low, even when the expected criterion is satisfied, it may not be the case that the machine learning model has high accuracy. As an example, there is a case in which the machine learning model has learned the dividing boundary in a complicated manner (it is difficult to perform linear approximation). Accordingly, when the accuracy of the machine learning model does not satisfy a criterion that is set more strictly than the expected criterion, the linear model generation unit 34 determines that the retraining is to be performed. For example, in a case where a linear approximation model is created using neighborhood data not satisfying the criterion, and a determination result of the neighborhood data based on the linear approximation model is compared with the inference result by the machine learning model, and when the matching rate is low (the approximation may be determined as failure), processing may be performed in which it is judged that the machine learning model is not suitable for the explanation based on the linear approximation (S16), and it is determined that the linear model generation unit 34 performs retraining (performs the training again).

When the retraining of the machine learning model is to be performed (S16: Yes), the linear model generation unit 34 notifies the machine learning unit 31 of the retraining and causes the machine learning unit 31 to retrain the machine learning model. The machine learning unit 31, when having received the notification from the linear model generation unit 34, starts the processing from S4 and retrains the machine learning model.

When the retraining of the machine learning model is not performed (S16: No), the linear model generation unit 34 returns the processing to S12. As for the presence or absence of the retraining of the machine learning model described above, a user may be notified of the presence or absence of the retraining of the machine learning model via the GUI or the like based on the accuracy (Acc) of the machine learning model, and a result judged by the user may be received from the GUI.

When the ratio (c1to0ratio) of the neighborhood data 24 satisfies the criterion (S15: Yes), the linear model generation unit 34 determines a distance function in accordance with the settings via the GUI or the like (S17). Subsequently, the linear model generation unit 34 generates a linear model g by the known method described above by using the neighborhood data 24, the inference result (prediction class) of the neighborhood data 24, and the distance function (S18).

Based on the generated linear model g, the output unit 35 calculates and outputs the explanatory score 26 (explanatory information) (S19).

As described above, the information processing apparatus 1 generates a plurality of pieces of neighborhood data based on the explanation target data. The information processing apparatus 1 calculates, among a plurality of results output when each of the plurality of pieces of neighborhood data is input to the machine learning model, the ratio of the output results different from the results output when the explanation target data is input to the machine learning model. Subsequently, when the calculated ratio satisfies the criterion, the information processing apparatus 1 generates a linear model g based on the plurality of pieces of neighborhood data and the results thereof, and outputs explanatory information for the results of the explanation target data based on the generated linear model g.

Explanatory accuracy (for example, R100) tends to be high in a case where the ratio (c1to0ratio) of change in class of the plurality of pieces of neighborhood data (output results of the machine learning model) with respect to the explanation target data satisfies the criterion (for example, 0.6 to 0.8). Accordingly, in a case where the above-described ratio satisfies the criterion, because the information processing apparatus 1 generates the linear model g related to the explanatory information by using the neighborhood data, it is possible to obtain the explanatory information with higher reliability.

The explanation target data in the information processing apparatus 1 is graph data indicating a graph structure including a plurality of nodes and edges each coupling the nodes to each other, and the information processing apparatus 1 generates a plurality of pieces of neighborhood data satisfying the conditions of the designated graph structure based on explanation target graph data. With this, as for the explanation target graph data, the information processing apparatus 1 may obtain more reliable explanatory information for the results output when the graph data is input to the machine learning model.

In a case where the ratio does not satisfy the criterion, the information processing apparatus 1 performs the processing of generating a plurality of pieces of neighborhood data to regenerate the plurality of pieces of neighborhood data, and calculates the ratio based on the regenerated plurality of pieces of neighborhood data. It is possible for the information processing apparatus 1 to regenerate a plurality of pieces of neighborhood data in this manner, and obtain such a plurality of pieces of neighborhood data that satisfies the criterion.

In a case where the ratio does not satisfy the criterion, the information processing apparatus 1 may retrain the machine learning model. For example, in a case where an expected criterion of the machine learning model is set to be relatively low, even when the expected criterion is satisfied, it may not be the case that the machine learning model has high accuracy. As an example, there is a case in which the machine learning model has learned the dividing boundary in a complicated manner (it is difficult to perform linear approximation). Accordingly, when the ratio does not satisfy the criterion, the information processing apparatus may obtain more reliable explanatory information by retraining the machine learning model.

Each constituent element of each apparatus illustrated in the drawings does not have to be physically configured as illustrated in the drawings at all times. For example, specific forms of the separation and integration of each apparatus are not limited to those illustrated in the drawings. The entirety or part of the apparatus may be configured in such a manner as to be functionally or physically separated and integrated in optional units in accordance with various loads, usage circumstances, and the like.

All or some of the various processing functions of the machine learning unit 31, the neighborhood data generation unit 32, the ratio calculation unit 33, the linear model generation unit 34, and the output unit 35 performed in the control unit 30 of the information processing apparatus 1, may be executed in a CPU (or a microcomputer such as an MPU or a microcontroller unit (MCU)). It goes without saying that all of or some optional portions of the various processing functions may be performed with a program analyzed and executed by a CPU (or a microcomputer such as an MPU or MCU) or with hardware by wired logic. The various processing functions performed by the information processing apparatus 1 may be performed by cloud computing in which a plurality of computers collaborates with each other.

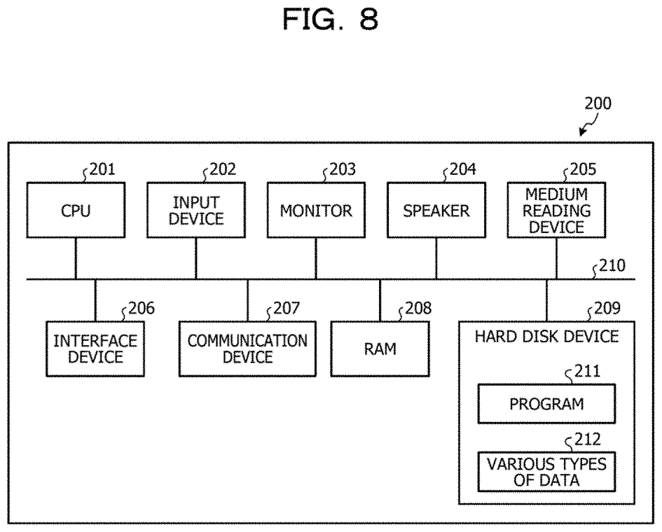

The various types of processing described in the above embodiment may be implemented by a computer executing a program prepared in advance. Hereinafter, an example of a computer configuration (hardware) that executes the program having the same functions as in the above-described embodiment will be described. FIG. 8 is a descriptive diagram for describing an example of the computer configuration.

As illustrated in FIG. 8, a computer 200 includes a CPU 201 configured to execute various types of arithmetic processing, an input device 202 configured to receive data input, a monitor 203, and a speaker 204. The computer 200 also includes a medium reading device 205 configured to read a program or the like from a storage medium, an interface device 206 for coupling to various devices, and a communication device 207 for coupling to external devices via wired or wireless communication. The computer 200 further includes a RAM 208 configured to temporarily store various types of information, and a hard disk device 209. Each of the constituent elements (201 to 209) in the computer 200 is coupled to a bus 210.

A program 211 for performing various types of processing in the functional configuration (for example, the machine learning unit 31, the neighborhood data generation unit 32, the ratio calculation unit 33, the linear model generation unit 34, and the output unit 35) described in the above embodiment is stored in the hard disk device 209. The hard disk device 209 also stores various types of data 212 to be referred to by the program 211. The input device 202 receives, for example, inputs of operation information from an operator. The monitor 203 displays, for example, various screens to be operated by the operator. For example, a printer or the like is coupled to the interface device 206. The communication device 207 is coupled to a communication network such as a local area network (LAN) and exchanges various types of information with the external devices via the communication network.

By reading out the program 211 stored in the hard disk device 209, and developing the program 211 in the RAM 208 and executing the developed program, the CPU 201 performs various types of processing related to the functional configuration described above (for example, the machine learning unit 31, the neighborhood data generation unit 32, the ratio calculation unit 33, and the linear model generation unit 34). The program 211 may not have to be stored in the hard disk device 209. For example, the program 211 stored in a storage medium readable by the computer 200 may be read out and executed. For example, as the storage medium readable by the computer 200, a portable storage medium such as a compact disc read-only memory (CD-ROM), a digital versatile disc (DVD) or a Universal Serial Bus (USB) memory, a semiconductor memory such as a flash memory, a hard disk drive, or the like may be used. The program 211 may be stored in a device coupled to a public network, the Internet, a LAN, or the like, and the computer 200 may read and execute the program 211 from the device.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing an explanatory program for causing a computer to execute a process, the process comprising:
generating a plurality of pieces of data based on first data;
calculating a ratio of output results, among a plurality of results output in a case that each of the plurality of pieces of data is input to a machine learning model, different from first results output in a case that the first data is input to the machine learning model;
generating a linear model based on the plurality of pieces of data and the plurality of results in a case that the calculated ratio satisfies a criterion; and
outputting explanatory information with respect to the first results based on the linear model.

2. The non-transitory computer-readable recording medium according to claim 1,
wherein the first data is graph data indicating a graph structure including a plurality of nodes and edges that couple the nodes to each other, and
the generating of the plurality of pieces of data includes generating the plurality of pieces of data that satisfies a condition of a designated graph structure based on the first data.

3. The non-transitory computer-readable recording medium according to claim 1, the process further comprising:
generating another plurality of pieces of data based on the first data in a case that the ratio does not satisfy the criterion;
calculating another ratio of results, among another plurality of results output in a case that each of the another plurality of pieces of data is input to the machine learning model, different from the first results;
generating another linear model based on the another plurality of pieces of data and the another plurality of results in a case that the another ratio satisfies the criterion; and
outputting another piece of explanatory information with respect to the first results based on the another linear model.

4. The non-transitory computer-readable recording medium according to claim 1, the process further comprising:
determining whether to retrain the machine learning model in a case that the ratio does not satisfy a criterion.

5. The non-transitory computer-readable recording medium according to claim 1,
wherein the criterion is such a criterion that the ratio is 60 to 80 percent.

6. An explanatory method performed by a computer, the method comprising:
generating a plurality of pieces of data based on first data;
calculating a ratio of output results, among a plurality of results output in a case that each of the plurality of pieces of data is input to a machine learning model, different from first results output in a case that the first data is input to the machine learning model;
generating a linear model based on the plurality of pieces of data and the plurality of results in a case that the calculated ratio satisfies a criterion; and
outputting explanatory information with respect to the first results based on the linear model.

7. The explanatory method according to claim 6,
wherein the first data is graph data indicating a graph structure including a plurality of nodes and edges that couple the nodes to each other, and
the generating of the plurality of pieces of data includes generating the plurality of pieces of data that satisfies a condition of a designated graph structure based on the first data.

8. The explanatory method according to claim 6, the method further comprising:
generating another plurality of pieces of data based on the first data in a case that the ratio does not satisfy the criterion;
calculating another ratio of results, among another plurality of results output in a case that each of the another plurality of pieces of data is input to the machine learning model, different from the first results;
generating another linear model based on the another plurality of pieces of data and the another plurality of results in a case that the another ratio satisfies the criterion; and
outputting another piece of explanatory information with respect to the first results based on the another linear model.

9. The explanatory method according to claim 6, the method further comprising:
determining whether to retrain the machine learning model in a case that the ratio does not satisfy a criterion.

10. The explanatory method according to claim 6,
wherein the criterion is such a criterion that the ratio is 60 to 80 percent.

11. An information processing apparatus comprising:
a memory, and
a processor coupled to he memory and configured to perform a process including:
generating a plurality of pieces of data based on first data;
calculating a ratio of output results, among a plurality of results output in a case that each of the plurality of pieces of data is input to a machine learning model, different from first results output in a case that the first data is input to the machine learning model;
generating a linear model based on the plurality of pieces of data and the plurality of results in a case that the calculated ratio satisfies a criterion; and
outputting explanatory information with respect to the first results based on the linear model.

12. The information processing apparatus according to claim 11,
wherein the first data is graph data indicating a graph structure including a plurality of nodes and edges that couple the nodes to each other, and
the generating of the plurality of pieces of data includes generating the plurality of pieces of data that satisfies a condition of a designated graph structure based on the first data.

13. The information processing apparatus according to claim 11, the process further including:
generating another plurality of pieces of data based on the first data in a case that the ratio does not satisfy the criterion;
calculating another ratio of results, among another plurality of results output in a case that each of the another plurality of pieces of data is input to the machine learning model, different from the first results;
generating another linear model based on the another plurality of pieces of data and the another plurality of results in a case that the another ratio satisfies the criterion; and
outputting another piece of explanatory information with respect to the first results based on the another linear model.

14. The information processing apparatus according to claim 11, the process further including:
determining whether to retrain the machine learning model in a case that the ratio does not satisfy a criterion.

15. The information processing apparatus according to claim 11, wherein the criterion is such a criterion that the ratio is 60 to 80 percent.
